(19) United States
(12) Patent Application Publication
(10) Pub. No.: US 2005/0133757 A1
(43) Pub. Date: Jun. 23, 2005

(54) Cold Storage agent, cold preserving material, and freezer

(75) Inventor: Masao Umemoto, Yokohama-shi (JP)

Correspondence Address: COOK, ALEX, MCFARRON, MANZO,;CUMMINGS & MEHLER, LTD., Suite 2850, 200 West Adams St., Chicago, IL, 60606, US

(73) Assignee: Shinya Satoh

(21) Appl. No.: 10/743,572

(22) Filed: Dec. 22, 2003

(51) Int. Cl. C09K 3/18

(52) U.S. Cl. 252/70

(57) ABSTRACT

A cold preserving material capable of maintaining the temperature of the inside of a freezer at −20° C. or lower for a long period of time is provided. Such a cold preserving material is obtained by freezing a mixture of sodium chloride and potassium chloride dissolved in water or a mixture of magnesium chloride and calcium chloride dissolved in water.

### BACKGROUND OF THE INVENTION

1. Field of the Invention

The present invention relates to a cold storage agent, a cold preserving material, and a freezer. In the present invention, the cold preserving material means a material obtained by dissolving the cold storage agent according to the present invention in water, and freezing the aqueous solution of the cold storage agent in a container. The freezer according to the present invention includes a freezing case and a transport container.

2. Description of Prior Art

As for a freezing mixture, a combination of NH₄Cl and KNO₃, a combination of NaNO₃ and NH₄NO₃, or a combination of KNO₃ and NH₄SCN is known. However, a cold storage agent which can be used as a substitute for dry ice, that is, a cold storage agent which can provide temperatures optimum for freezing (−35 to −50° C.) has not yet been found.

### SUMMARY OF THE INVENTION

The present invention provides a cold storage agent comprised of a combination of two kinds of salts capable of providing a lower temperature as compared with a cold storage agent comprised of a single salt, and a cold preserving material obtained by dissolving such a cold storage agent in water, and freezing the aqueous solution of the cold storage agent in a container made of polyethylene or the like and having a thickness of 1 to 3 mm. More specifically, the present invention provides a cold storage agent comprised of a combination of salts capable of obtaining a cold storage effect of maintaining a low temperature of −35° C. or lower, and a cold preserving material prepared using such a cold storage agent. Further, the present invention provides a freezer which contains such a cold preserving material capable of providing a low temperature of −35° C. or lower, and can maintain the temperature of the inside thereof at −20° C. or lower.

The present inventor has prepared an aqueous solution of the cold storage agent comprised of a combination of at least two salts composed of identical negative ions and different positive ions. An example of a negative ion includes chloride ion, sulfate ion, or nitrate ion. The salt may be a monovalent salt or a bivalent salt. In the case of a monovalent salt, an example of a positive ion includes sodium ion, potassium ion, or ammonium ion. In the case of a bivalent salt, an example of a positive ion includes magnesium ion or calcium ion.

In two salts, negative ions should be identical, and a combination of positive ions should be a combination of monovalent ion and monovalent ion, or a combination of bivalent ion and bivalent ion. That is, the cold storage agent of the present invention is comprised of a combination of a salt composed of a monovalent negative ion and a monovalent positive ion and a salt composed of a monovalent negative ion and a monovalent positive ion. A combination of a salt composed of a monovalent negative ion and a monovalent positive ion and a salt composed of a monovalent negative ion and a bivalent positive ion should be excluded.

As described above, in the present invention, an example of a negative ion includes chloride ion, sulfate ion, or nitrate ion. Among them, chloride ion (Cl⁻) is preferable because it has been confirmed from experimental results that chloride ion has the effect of markedly lowering melting point and prolonging cold storage duration. As for a positive ion, in the case of a monovalent salt, sodium ion (Na⁺), potassium ion (K⁺), or ammonium ion (NH₄⁺) can be mentioned. In the case of a bivalent salt, magnesium ion (Mg²⁺) or calcium ion (Ca²⁺) is preferable.

Accordingly, in the present invention, a preferred example of a combination of monovalent salts includes a combination of NaCl and KCl, a combination of NaCl and NH₄Cl, a combination of KCl and NH₄Cl, or a combination of NaCl, KCl and NH₄Cl. As for a combination of bivalent salts as chloride, a combination of MgCl₂ and CaCl₂ can be mentioned.

Among bivalent salts, a combination of a bivalent salt composed of chloride ion as a negative ion and calcium ion as a positive ion and a bivalent salt composed of chloride ion as a negative ion and magnesium ion as a positive ion is preferable in terms of lowering of melting point and prolongation of cold storage duration as compared with a single chloride salt. Further, such combined bivalent salts can provide a low temperature of −37° C. (in the case of a combination of magnesium chloride as a main component and calcium chloride) or −45° C. (in the case of a combination of calcium chloride as a main component and magnesium chloride), and therefore a cold storage agent comprised of such combined bivalent salts can be used as a substitute for dry ice.

Furthermore, a freezer or a transport container capable of maintaining the temperature of the inside thereof at a low temperature of −20° C. or lower for a long period of time can be achieved by setting a cold preserving material obtained by freezing such a cold storage agent of the present invention in an accommodation member, in the inside of the freezer. Since such a cold preserving material can maintain the temperature of the inside of the freezer at −20° C. or lower for a long period of time, it can be suitably used for freezing food, as a substitute for dry ice. The cold preserving material is preferably set in the upper portion of the freezer, but it is not always necessary to set the cold preserving material in the upper portion of the freezer as long as air in the freezer is stirred by using a fan.

### BRIEF DESCRIPTION OF THE DRAWINGS

FIG. 1 is a graph which provides a comparison of a change in surface temperature between a cold preserving material according to the present invention and a conventional cold preserving material; and

FIG. 2 is a schematic illustration which shows the inside of a freezer containing the cold preserving material according to the present invention.

### DETAILED DESCRIPTION OF THE INVENTION

Hereinbelow, a description will be made with regard to embodiments of the present invention.

½ to 1/10, preferably, ⅓ to ⅕ wt % of ammonium chloride (NH₄Cl) is added with respect to 1 wt % of sodium chloride (NaCl) or potassium chloride (KCl). Alternatively, ⅓ to ⅕ wt % of sodium chloride (NaCl) or potassium chloride (KCl) may be added with respect to 1 wt % of ammonium chloride (NH₄Cl). Here, wt % means the weight percentage of salt dissolved in water (salt weight g in 100 g solution).

The basic concept regarding “with respect to” is as follows: ⅓ to ⅕ amount (wt %) of a main component is reduced from an optimum amount of the main component when used singly, and another salt is added by ⅓ to ⅕ amount (wt %). Alternatively, another salt is added by ⅓ to ⅕ amount (wt %) to the optimum amount of main component, wherein the total amount is increased by ⅓ to ⅕ (wt %).

The same thing can be said for the case of a combination of bivalent salts (magnesium chloride (MgCl₂) and calcium chloride (CaCl₂)). For example, calcium chloride (CaCl₂) is added by ½ to 1/8 amount (wt %) to the optimum amount of magnesium chloride (MgCl₂). Alternatively, reducing magnesium chloride (MgCl₂) by ½ to 1/8 amount (wt %), and adding calcium chloride (CaCl₂) by ½ to ⅛ amount (wt %).

It is preferred that the weight percentage of the main component dissolved in water is in the range of 10 to 25. The thus obtained cold storage agent is dissolved in water to prepare an aqueous solution thereof, and the prepared aqueous solution is placed in a container made of polyethylene or the like and then frozen, to obtain a cold preserving material.

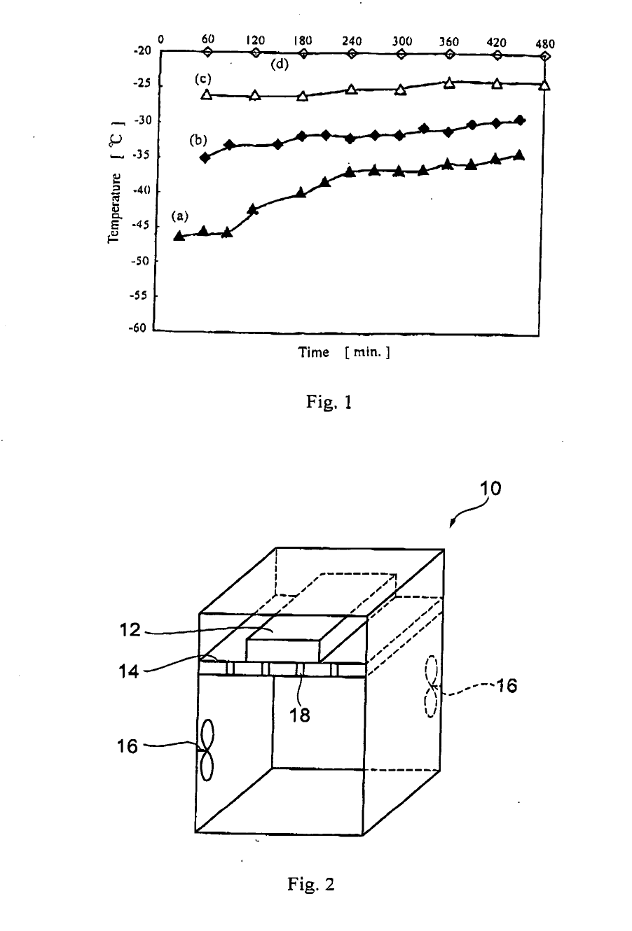

In the present invention, the cold preserving material obtained by dissolving a mixture of magnesium chloride (MgCl₂) as a main component and calcium chloride (CaCl₂) in water and freezing the aqueous solution of the mixture can maintain a low temperature of −36° C. and has a longer cold storage duration as compared with a cold preserving material comprised of magnesium chloride (MgCl₂) alone. On the other hand, the cold preserving material comprised of a mixture of calcium chloride (CaCl₂) as a main component and magnesium chloride (MgCl₂) can provide a lower temperature of −45° C. Therefore, such a cold preserving material obtained by freezing the cold storage agent of the present invention in a container can be used as a substitute for dry ice. Further, the cold preserving material obtained by dissolving a mixture of sodium chloride (NaCl) as a main component (having a melting point of −20° C. when used singly) and ammonium chloride (NH₄Cl) in water, and freezing the aqueous solution of the mixture has a lower melting point of −25° C. and a long cold storage duration (see FIG. 1). As described above, such a mixed cold storage agent (cold preserving material) has an excellent cold storage effect as compared with a cold storage agent (cold preserving material) comprised of a single component.

FIG. 2 is a schematic illustration which shows the inside of the freezer containing the cold preserving material according to the present invention. As shown in FIG. 2, a cold preserving material 12 obtained by freezing the cold storage agent dissolved in water contained in an accommodation member is placed inside a freezer 10. A transport container is also included in such a freezer. The cold preserving material is placed in the upper portion of the freezer, and therefore, a storage part 14 for setting the cold preserving material is provided in the upper portion of the freezer. The freezer may have a fan 16 for uniformly filling the inside of the freezer with cold air generated by the cold preserving material placed in the storage part 14, and further a cold air blowing means 18 for blowing cold air generated by the cold preserving material placed in the upper portion of the freezer in the downward direction.

### EXAMPLE 1

Each of a 23 wt % aqueous sodium chloride solution, and an aqueous solution containing 17 wt % of sodium chloride and 5 wt % of ammonium chloride was placed in a container made of polyethylene and having a thickness of 1 mm, and then frozen. Thereafter, the melting point of each of the frozen aqueous solutions was measured, and the former was −20° C. and the latter was −25° C. These frozen aqueous solutions had the same cold storage duration.

### EXAMPLE 2

Each of a 20 wt % aqueous potassium chloride solution, and an aqueous solution containing 15 wt % of potassium chloride and 5 wt % of ammonium chloride was placed in a container made of polyethylene and having a thickness of 1 mm, and then frozen. Thereafter, the melting point of each of the frozen aqueous solutions was measured, and the former was −10.5° C. and the latter was −17° C. These frozen aqueous solutions had the same cold storage duration.

### EXAMPLE 3

Each of a 20 wt % aqueous ammonium chloride solution and an aqueous solution containing 20 wt % of ammonium chloride and 5 wt % of potassium chloride was placed in a container made of polyethylene and having a thickness of 1 mm, and then frozen. Thereafter, the melting point of each of the frozen aqueous solutions was measured, and the former was −16° C. and the latter was −17.5° C. The cold storage duration of the latter was 1.15 times longer than that of the former.

### EXAMPLE 4

TABLE 1

| | minutes | | | | | | |
|---|---|---|---|---|---|---|---|
| | 60 | 120 | 180 | 260 | 300 | 360 | 420 |
| MgCl₂ 15% | −81 | −31 | −31 | −29 | −23 | −15 | −12 |
| MgCl₂ 15 + | −42 | −40 | −36 | −33 | −26 | −16 | −5 |
| CaCl₂ 5% | | | | | | | |
| MgCl₂ 15 + | −42 | −34 | −32 | −30 | −24 | −15 | −12 |
| CaCl₂ 2.5% | | | | | | | |
| MgCl₂ 20 + | −45 | −37 | −34 | −29 | −18 | −8 | −3 |
| CaCl₂ 7.5% | | | | | | | |
| MgCl₂ 20 + | −35 | −34 | −33 | −30 | −20 | −7 | −3 |
| CaCl₂ 2.5% | | | | | | | |

A 15 wt % aqueous magnesium chloride solution, an aqueous solution containing 15 wt % of magnesium chloride and 2.5 wt % of calcium chloride, an aqueous solution containing 15 wt % of magnesium chloride and 5 wt % of calcium chloride, an aqueous solution containing 20 wt % of magnesium chloride and 7.5 wt % of calcium chloride, and an aqueous solution containing 20 wt % of magnesium chloride and 2.5 wt % of calcium chloride were prepared as cold storage agents. Each of the cold storage agents was placed in a container made of polyethylene and having a thickness of 1 mm and a capacity of 550 mL, and was then frozen. The thus obtained each of the cold preserving materials was placed in a styrofoam box having a size of 30×21×12 cm and a thickness of 2 cm, and a change in surface temperature of cold preserving material was measured. The melting point of each of the cold preserving materials is shown in Table 1.

The cold preserving material comprised of 15 wt % of magnesium chloride alone had a melting point of −31° C. On the other hand, in the case of the cold preserving material comprised of a mixture of magnesium chloride and calcium chloride, the cold preserving material containing 2.5 wt % of calcium chloride had a lower melting point as compared with the cold preserving material comprised of magnesium chloride alone, and the cold preserving material containing 5 wt % or more of calcium chloride had a markedly lowered melting point. Further, the cold preserving material containing 20 wt % of magnesium chloride had a still lower melting point.

Moreover, (a) a cold preserving material containing 15 wt % of magnesium chloride and 5 wt % of calcium chloride, (b) a cold preserving material containing 15 wt % of magnesium chloride alone, (c) a cold preserving material containing 17 wt % of sodium chloride and 5 wt % of ammonium chloride, and (d) a cold preserving material containing 23 wt % of sodium chloride alone were prepared. For each of the cold preserving materials, a change in surface temperature of cold preserving material when two blocks of the cold preserving material were placed in a freezer was measured. The result is shown in FIG. 1, wherein ▴-▴ represents the cold preserving material (a), ♦-♦ represents the cold preserving material (b), Δ-Δ represents the cold preserving material (c), and ⋄-⋄ represents the cold preserving material (d). As shown in FIG. 1, the cold preserving material comprised of a mixture of chloride salts showed a lower temperature as compared with the cold preserving material comprised of a single chloride salt, and there was no difference in change in surface temperature with the passage of time between them. Specifically, the cold preserving material comprised of a mixture of magnesium chloride and calcium chloride (a) showed a lower temperature as compared with the cold preserving material comprised of magnesium chloride alone (b). Similarly, the cold preserving material comprised of a mixture of sodium chloride and ammonium chloride (c) showed a lower temperature as compared with the cold preserving material comprised of sodium chloride alone (d). In addition, there was no difference in change in surface temperature with the passage of time between them.

### EXAMPLE 5

A cold preserving material comprised of 10 wt % of potassium chloride alone had a melting point of −11° C. On the other hand, a cold preserving material comprised of a mixture of 10 wt % of potassium chloride and 3 wt % of ammonium chloride had a melting point of −13° C.

### EXAMPLE 6

A cold preserving material comprised of 15 to 17 wt % of calcium chloride alone had a melting point of −44° C. On the other hand, a cold preserving material comprised of a mixture of 15 wt % of calcium chloride and 5 wt % of magnesium chloride had a melting point of −47.5° C.

1. A cold storage agent comprising a combination of two salts composed of identical negative ions and different positive ions having the same valence, the valence being monovalence or bivalence.

2. The cold storage agent as claimed in claim 1, wherein the monovalent positive ion is one of sodium ion, potassium ion and ammonium ion, and the negative ion is chloride ion.

3. The cold storage agent as claimed in claim 1, wherein the bivalent positive ion is one of magnesium ion and calcium ion, and the negative ion is chloride ion.

4. The cold storage agent as claimed in any one of claims 1 to 3, wherein the concentration of main component dissolved in water is in the range of 10 to 25 wt %.

5. The cold storage agent as claimed in claim 4, wherein the cold storage agent is obtained by mixing sodium chloride or potassium chloride as a main component and ammonium chloride, wherein ½ to 1/10, preferably, ⅓ to ⅕ wt % of ammonium chloride is added with respect to 1 wt % of sodium chloride or potassium chloride.

6. The cold storage agent as claimed in claim 4, wherein the cold storage agent is obtained by mixing ammonium chloride as a main component and sodium chloride or potassium chloride, wherein ⅓ to 1% wt % of sodium chloride or potassium chloride is added with respect to 1 wt % of ammonium chloride.

7. The cold storage agent as claimed in claim 4, wherein the cold storage agent is obtained by mixing magnesium chloride as a main component and calcium chloride, wherein ½ to 1/8 wt % calcium chloride is added with respect to 1 wt % of magnesium chloride.

8. The cold storage agent as claimed in claim 4, wherein the cold storage agent is obtained by mixing calcium chloride as a main component and magnesium chloride, wherein ½ to ⅛ wt % of magnesium calcium chloride is added with respect to 1 wt % of calcium chloride.

9. A cold preserving material obtained by freezing the cold storage agent as claimed in claim 1 dissolved in water contained in an accommodation member.

10. A freezer which contains a cold preserving material obtained by freezing the cold storage agent as claimed in claim 1 dissolved in water contained in an accommodation member in the inside thereof.

11. The freezer as claimed in claim 10, wherein the freezer is a container.

12. The freezer as claimed in claim 10 or 11, further comprising a fan in the inside thereof.

13. The freezer as claimed in claim 12, wherein the cold preserving material is provided in the upper portion thereof.

14. The freezer as claimed in claim 13, further comprising a cold air blowing means for blowing cold air generated by the cold preserving material provided in the upper portion thereof in the downward direction.
